(19) United States
(12) Patent Application Publication
(10) Pub. No.: US 2007/0203739 A1
(43) Pub. Date: Aug. 30, 2007

(54) Method of providing an interactive service procedure graphic display

(76) Inventor: Frank Williams, Los Alamitos, CA (US)

Correspondence Address: Frank John Williams, 2711 Saint Albans dr, Los Alamitos, CA, 90720, US

(21) Appl. No.: 11/703,422

(22) Filed: Feb. 5, 2007

Related U.S. Application Data
(60) Provisional application No. 60/764,931, filed on Feb. 3, 2006.
(60) Provisional application No. 60/780,473, filed on Mar. 8, 2006.

(51) Int. Cl. G06Q 10/00; G06Q 30/00

(52) U.S. Cl. 705/1

(57) ABSTRACT

A method for providing a means for providing service information of an apparatus such as movies demonstrating service procedures and other service information important or relevant to at least one of a: viewer, said apparatus, and said service procedure. The method teaches a graphic display to allow for interactivity with the content of the providing service information. The method further enables the viewer to intuitively interact with many sources of information, tools, and/or means for assistance and reference of service information.

### RELATED APPLICATIONS

This application claims the benefit of: provisional patent application Ser. No. 60/764,931 filed Feb. 3, 2000 and provisional patent application 60/780,473 filed Mar. 8, 2006 by the present inventor.

### BACKGROUND

1. Field of the Present Disclosure

This disclosure relates to a graphic display and methods for providing service information. More specifically, a method for providing an interactive graphic display providing service information such as a movie demonstrating a service procedure, and any other service information such as other, events, unfortunate events and/or parts associated to the service procedure or belonging to an apparatus.

2. Description of Related Art

Because of the evolution of the modern machine, service procedures to keep them running and functional have also evolved into complex and elaborate service procedures. Consequentially, the amount of information and/or parts required to ensure them successful depends on many factors such as: the procedure, technical experience, technical expertise, parts, events and possible unfortunate events encountered during the procedure and other to name a few. Furthermore, large quantities of money, time and resources are spent every day training, educating, supporting, warranting, and assisting technicians and end-users alike.

Thanks to the recent digital revolution, people can readily access rich means of information such as still pictures, slide-shows, movies and other graphic display means. From this group, movies in particular offer the richest and most powerful way for providing plentiful information such as a demonstration of a service procedure of an apparatus. However, even when potentially any of these graphic displaying means can easily be used to disseminate, demonstrate, teach or provide the important service information, they still may lack the ability of providing all service information such as addressing particular circumstances, inquiries, events, unfortunate events, and other possibilities that a technician or end-user could encounter at any time before, during or after a service procedure. For example, an end-user is viewing a movie demonstrating the service procedure of “how to replace the feed rollers” of a laser printer. The movie shows a door of the printer being opened, and continues along with other service actions; but the user viewing the movie can not open the door as shown in the movie. Rewinding the movie and viewing the “opening of the door” many times again will not add any additional or detailing information. Also, including such detailing information of “what to do if the opening of the door is unsuccessful” will render the movie longer, boring or even confusing to other viewers not affected by the particular unfortunate event, thus rendering the movie and method of teaching irrelevant.

Recently, a new series of approaches have being conceived intending to alleviate the inconveniences of technical information distribution. Patents such as: U.S. Pat. No. 6,317,570 Uchida et al, U.S. Pat. No. 5,802,429 Yamashita, US patent application publication US 2004/0186598 A1 Tanaka, and U.S. Pat. No. 5,715,496 Sawada et al, disclose several methods of obtaining information directly from the apparatuses for intents of remote diagnosis, and possible equipment management. Unfortunately they all fail of providing repair information to the viewer for servicing the apparatus. In addition U.S. Pat. No. 7,149,936 Deshpande, U.S. Pat. No. 6,188,938 Collins-Rector et al, U.S. Pat. No. 6,106,302 Schumacher, disclose teaching methods for providing information, yet they also fail to provide service and repair information.

In view of the foregoing and shortcomings, the disclosed inventive graphic display and methods teaches away from the recently used methodologies, while solving felt needs and provides unappreciated advantages distinguishing it over the prior art by also providing heretofore additional unknown advantages as described in the following summary.

### SUMMARY

It is therefore the object of the present invention to teach a method for providing an interactive graphic display for providing service information such as a movie demonstrating a service procedure, and other service information such as additional information, relevant information, circumstantial information, and/or associated information to a service procedure of an apparatus. In such fashion, viewers can quickly, objectively, and affordably access important service information, without the limitations of current graphic display means used to provide service information. Furthermore, the method comprises the ability of adapting and managing current and/or new service information. This disclosure teaches certain benefits in construction and use which give rise to the objectives described below.

A primary objective inherent in the above described method is to provide advantages not taught by the prior art;

Another objective is to provide for the demonstration of elaborate and complex procedures;

Another objective is to provide a service procedure demonstrating an unfortunate event;

Another objective is to allow for quick dissemination of service information;

Another objective is to quickly permit the removal and/or addition of service information;

Another objective is to provide an intuitive method for viewers to obtain service information;

Another objective is to avoid the extrapolation of parts information;

Another objective is to diminish stress and tension experienced by the technician or end-user when performing service procedures;

Another objective is to avoid the speculation of service procedures upon an unfortunate event;

Another objective is to fulfill the end-users' needs to service their own equipment;

Another objective is to standardize the quantity and quality of service information;

Another objective is to alleviate warranty related repairs and/or expenses;

Another objective is to provide manufacturers' with a more compelling and complete medium to distribute service procedure information;

A further objective is to allow manufacturers and/or technical entities to quickly introduce or add new service procedure information handling unfortunate service events;

A further objective is to eliminate the possibility of identifying and/or ordering incorrect parts not relating to the relevant service procedure;

A further objective is to increase the troubleshooting success rate of technicians and end-users alike;

Other features and advantages of the described methods of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate at least one of the best mode embodiments of the present invention and method of use. In such drawings:

FIG. 1 illustrates a general non-limiting view of an exemplary inventive Interactive Service Information Graphic Display (ISIGD);

FIG. 2 illustrates an exemplary parts' menu of an ISIGD;

FIG. 3 illustrates a non-limiting view of an ISIGD comprising several types of input graphic elements (buttons) behaviors;

FIG. 4 illustrates a sample browsing between several ISIGD;

FIG. 5 illustrates a non-limiting time chart of an exemplary primary service information such as a movie and other secondary service information;

FIG. 6 illustrates a non-limiting flow chart of a primary service information demonstrating a service procedure, and other possible service information associated to the service procedure;

FIG. 7 illustrates a non-limiting ISIGD designed to provide service information of a preventive maintenance procedure, and other service information.

### DETAILED DESCRIPTION OF THE PREFERRED EMBODIMENT

The above described drawing figures illustrate the described Interactive Service Information Graphic Display (ISIGD) and methods in at least one of its preferred, best mode embodiment, which is further defined in detail in the following description. Those having ordinary skill in the art may be able to make alterations and modifications for what is described herein without departing from its spirit and scope. Therefore, it must be understood that what is illustrated is set forth only for the purposes of example and that it should not be taken as a limitation in the scope of the present apparatus and method of use.

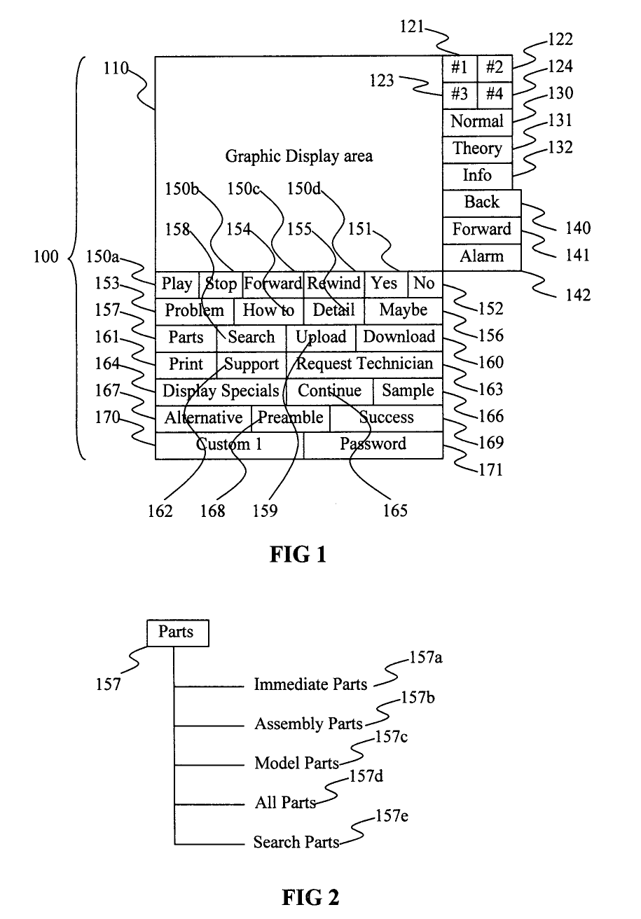

FIG. 1 illustrates a general non-limiting illustration of an exemplary Interactive Service Information Graphic Display 100 (FIG. 1). In FIG. 1, the display area 110 (FIG. 1) is where some or most of the service information is preferably displayed, for example a movie demonstrating a service procedure such as “replacing the rollers of a laser printer.” The service information been display is controlled by Several Input Graphic Elements or buttons, such as “Play” button 150a (FIG. 1) used to start the movie, the “Stop” button 150b (FIG. 1) used to pause the movie, the “Forward button” 150c (FIG. 1) used to advance the content of the movie, and the “Rewind” button 150d (FIG. 1) used to reverse the movie's content. Other Input Graphic Elements illustrated are the exemplary “selective type,” buttons such as #1 121 (FIG. 1), #2 122 (FIG. 1), #3 123 (FIG. 1), and #4 124 (FIG. 1); which are used to give the viewer the option to select and/or choose at least one of them in response to the service information being provided in the graphic display area 110 (FIG. 1). For example, a movie demonstrating to a viewer how to replace the rollers of his laser printer, displays four still images numbered from 1 to 4 illustrating worn rollers. Upon selecting the image that best matches the worn rollers in his printer, the viewer clicks the corresponding button, such as #1 121 (FIG. 1), which leads the viewer to another service information such as another movie demonstrating a service procedure associated to the type of worn experienced by the rollers of the printer. The button named “Normal” 130 (FIG. 1) is a reference information type button, providing information considered customary and/or of acceptable status. For example, a viewer watching a movie demonstrating the replacement of rollers in his printer, double clicks the “Normal” button 130 (FIG. 1) to obtain information ultimately containing sound sample of noises considered to be a normal during or after a replacement service procedure. The information button named “Theory” 131 (FIG. 1) provides information on theory relating to at least one of a: apparatus, service procedure, other service information, other apparatus, and other types of service information. For example, a viewer watching a movie demonstrating the replacement of roller in his printer clicks the “Theory” button 131 (FIG. 1) to view a movie discussing the theory of the paper feed and paper pickup mechanism and operation of the laser printer. The button named “Info” 132 (FIG. 1) provides identifying information. For example, a viewer clicks the “Info” button 132 (FIG. 1) and a table is displayed providing information such as: the movie name and/or number, the length of the movie, the degree of service difficulty, and other identifying information associated to the movie or other. The “Back” button 140 (FIG. 1) and the “Forward” button 141 (FIG. 1) are navigational type buttons to browse and navigate between the different information files being implemented. For example, a viewer watching a movie demonstrating roller replacement clicks the “Theory” button 131 (FIG. 1). As a result, a new ISIGD (or player) is opened (or current displayed information is changed) with a movie discussing the theory of the paper feed mechanism of the printer. When the viewer clicks the “Back” button 140 (FIG. 1), the previous or initial ISIGD continues or re-starts to display the previous service information such as the movie demonstrating the replacement of the printer's rollers. In similar fashion, clicking of the “Forward” button 141 (FIG. 1) will bring the viewer back to the movie discussing the theory of the paper feed mechanism. The button named “Alarm” 142 (FIG. 1) is a “stop and/or wait for input” type button. For example, while the movie demonstrating the replacement of the printer's rollers is displayed, the alarm button 142 (FIG. 1) starts blinking, and the movie is automatically paused. In order to continue with the service procedure, the viewer must click the “Alarm” button 142 (FIG. 1) to access warning information such as pictures, protocols, and/or others. Optionally, only a few functions such as the “rewind” function on the information control 150 (FIG. 1) remains or becomes functional when such alarm situation is imposed upon the viewer. The buttons named “Yes” 151 (FIG. 1), “No” 152 (FIG. 1), and “Maybe” 156 (FIG. 1) are used to by the viewer to respond positively, negatively or uncertainly to information request by service information. For example, the movie demonstrating the roller replacement asks if oil present in the gears next to a roller. In this particular moment, the viewer must answer “yes” or “no” in order to continue with its respective service information. On the other hand, clicking the “Maybe” button 156 (FIG. 1) in this example, will display a movie or start a new ISIGD aimed to help the viewer decide if indeed oil is present in the neighboring gear(s) of the rollers. The button named “Problem” 153 (FIG. 1) is implemented to provide service information covering or addressing any problem(s) possibly encountered when performing the exemplary service procedure being demonstrated. For example, the movie demonstrating the replacement of the printer's rollers shows how to remove the paper supply unit (cassette). When the viewer intends to remove the paper cassette as shown, he/she fails to do so. Clicking the “Problem” button 153 (FIG. 1) while the movie mentions the removal of the paper cassette, provides another service information, such as another movie describing and/or demonstrating additional procedures to remove the paper cassette mentioned. In another example, clicking the “Problem” button 152 (FIG. 1) provides a list of names of movies that demonstrate possible problems encountered during a service procedure, such as the name “paper supply can not be opened” for displaying a movie addressing such topic. The button named “How to” 154 (FIG. 1) as implied by its name, is used to identify other service information, such as a movie demonstrating other/additional service procedure(s) not demonstrated by the current service information. For example, the movie demonstrating the roller replacement of a printer, mentions to remove the printer cartridge, yet it never shows how to do it. While is true that most viewers know “how to remove the cartridge,” a new or occasional viewer probably does not know or remember. Therefore, the “How to” button 152 (FIG. 1) provides the new or occasional viewer imperative service information while at the same time saves such viewer plenty of time and/or frustration. The button named “Detail” 155 (FIG. 1) provides the viewer more detailing service information, such as a zoom-in or zoom-out version of the content being illustrated. For example, during the movie a particular a roller of the printer is shown or discussed. By clicking the “Detail” button 155 (FIG. 1) the viewer can see an close-up slide show per se, of that particular region of the printer and roller. The button named “Parts” 157 (FIG. 1) is used to provide parts' information and/or other type of information relative to such parts. For example, when the viewer opens a door in the printer as shown in the movie, he/she notices that his/her printer's door is broken or damaged. Clicking the “Parts” button 157 (FIG. 1) provides the viewer parts information such as diagrams with part numbers. Optionally, it also provides an ordering protocol to order or purchase the part such as the damaged door, facilitating service information of parts, while at the same time, avoids the possibility of ordering the incorrect part or door. The button named “Search” 158 (FIG. 1), is used to find particular information or a section of the service information. For example, the viewer remembers that in the movie demonstrating the “replacement roller” service procedure, the host in the movie mentions a “black bushing.” By clicking the “Search” button 158 (FIG. 1) the viewer is provided with a search engine to search for words such as “black bushing,” and find the portion and/or video, wherein the words “black bushing” are mentioned. Another suggested button (or function) of the preferred embodiment is the “Upload” button 159 (FIG. 1), which provides the viewer the ability to send service information, such as sending a picture of a particular damage part of his/her apparatus. For example, the viewer observes that the printer has a distinctive noise after replacing a part. The “Normal” button 130 (FIG. 1) does not provide any information referring to such noise. By clicking the “Upload” button 130 (FIG. 1), the viewer can send or upload a sound file of the noise affecting his/her apparatus suggestively to another location such as technical support for further assistance identifying the particulars of such noise. The “Download” button 160 (FIG. 1), allows the viewer to download or obtain service information pertinent to any service information involved. For example, the service information such as the movie demonstrating the replacement of the rollers mentions a new version of software for the printer allowing for better apparatus performance. The viewer can readily obtain such software simply by clicking the “Download” button 160 (FIG. 1). In another example, the viewer is watching a demonstration of “how to setup the printer in a large network” and is told to select a driver (software) from the “Download” button 160 (FIG. 1). The “Print” button 161 (FIG. 1) is used to print any service information the viewer decides. For example, the viewer decides to print a picture or image from a movie currently demonstrating a service procedure. Simply by clicking the “Print” button 161 (FIG. 1) a protocol appears allowing the viewer to print or save a slide or still image from the movie. The “Support” button 162 (FIG. 1) allows the viewer to communicated with technical support or other type of support entity. For example, the viewer recognizes the necessity to communicate or talk with technical support. Simply by clicking the “Support” button 162 (FIG. 1) opens a choice of mediums available to establish communications with an entity or to establish communications with a new entity of choice, such as an electronic chat, thus allowing the viewer to quickly instant-message a support department for assistance. In another example, the “Support” button 162 (FIG. 1) is used to access another computer capable of providing further support and/or service information. The “Request Technician” button 163 (FIG. 1) provides at least one option to request the dispatch of a field technical representative to the physical location of the apparatus. For example, the viewer feels that the service procedure being demonstrated seems too difficult and decides to request a technician instead. Simply by clicking the “Request Technician” button 163 (FIG. 1) a protocol allows the viewer to request the physical visit of a technical support representative. The “Display Specials” button 164 (FIG. 1) is an advertising type button. For example, the viewer performing the service procedure of “replacing the rollers” clicks the “Display Specials” button 164 (FIG. 1), immediately a banner appears displaying special prices of parts and/or other apparatuses, such as discounted prices on “bushings” for the rollers mentioned in the roller replacement movie. In another sample, the “Display Specials” button 164 (FIG. 1) is interactive, such as simply displaying text mentioning a special. Simply by clicking on the button (or text), allows the viewer to interact with information and/or protocol announcing the special. The “Continue” button 165 (FIG. 1) allows the viewer to continue the ISIGD at a later time. For example, the viewer watching the demonstration of a “roller replacement” is interrupted and decides to continue with the procedure sometime later. Clicking the “Continue” button 165 (FIG. 1) provides a protocol allows the viewer to stop and program a scheduled to proceed with the ISIGD at a later date or time. The “Sample” button 166 (FIG. 1) is for sampling service information, such as allowing the viewer to see additional samples. For example, the “roller replacement” procedure mentions and illustrates a bad roller. The viewer can activate the “Samples” button 166 (FIG. 1) to see other samples of bad rollers. In another example, a movie mentions to access or click the “Samples” button 166 (FIG. 1) to view sampling images of worn parts. The “Alternative” button 167 (FIG. 1) is used to identify alternative service information such as other movies demonstrating alternative service procedures. For example, a viewer is watching a movie demonstrating a service procedure and notices that rollers of his/her printer are damaged and need immediate replacement. However, such rollers are not at hand. Simply by clicking the “Alternative” button 167 (FIG. 1), the viewer is provided with emergency or alternative procedures demonstrating what to do temporarily or how to clean the roller temporarily in order to resume temporary functional status of the apparatus (printer). The “Preamble” button 168 (FIG. 1) provides a small and brief re-enactment(s) of the service information such as the reenacting of a service procedure, thus allowing the viewer to acknowledge the major steps involved. For example, a viewer would like to know the major parts and/or actions involve in the “roller replacement” service procedure. Simply by clicking the “Preamble” button 168 (FIG. 1), the viewer can see the parts involved and a discussion of the major steps involved in replacing the rollers. Suggestively, the viewer can decide to proceed with the service replacement procedure or instead call a technician to replace the rollers. In another example, a technician clicks on the “Preamble” button 168 (FIG. 1) to remember or overview the steps involved of a particular service procedure. The “Success” button 169 (FIG. 1) is used to close and/or to inform other entities that the service information such as a service procedure was performed successfully. For example, the viewer watches a slide show of “how to replace the printer's rollers” and successfully finishes the service procedure(s). Simply by clicking the “Success” button 169 (FIG. 1) the viewer closes the ISIGD. In another example, clicking the “Success” button 169 (FIG. 1) is used to update information that the service procedure(s) was completed successfully, such as those situations involving the updating of information as encountered with preventive maintenance procedures and schedules. The button labeled “Custom 1” 170 (FIG. 1) is used to identify service information exclusive to at least one of a: industry, apparatus, support entity, and viewer. For example, an ISIGD used in the repair of an airplane, may want to implement a custom button labeled “Voltages” or “Hydraulic pressures” allowing technical personnel to view tables with the different voltages allowances or pressures permitted, associated with the particular service procedure(s). The button labeled “Password” 171 (FIG. 1) allows the viewer to access the service information contained and/or displayed by the ISIGD. For example, in a military application, the service information of “adjusting the engines' afterburner flaps” of a jet fighter plane, are considered to be secret. Only personal with passwords can view or access the information on the ISIGD. Optionally, the media displayed by the ISIGD is encrypted to at least one of a: ISIGD, password(s) and/or any other type information, physical items, permissions, and security keys.

FIG. 2 illustrates a non-limiting example of a parts menu of an ISIGD. In this example, the “Parts” button 157 (FIG. 2) provides a parts menu comprising of several types of parts information associated to the service procedures and/or the apparatus(s). Additional service information such as a shopping cart (parts ordering protocol) can generate valuable commercial applications for many entities, such as the viewer, the providers of the ISIGD, and information providers for the ISIGD and/or third parties. The “Immediate Parts” 157a (FIG. 2), provides information of only those parts immediately involved in the service procedure. Furthermore, it optionally provides a shopping cart to acquire such parts. For example, a viewer watching a movie demonstrating a service procedure of “how to replace the roller in a printer,” clicks the “Immediate Parts” button 157a (FIG. 2), causing the movie to pause and to display information such as the part number of the rollers described in the movie. The “Assembly Parts” 157b (FIG. 2) provides the viewer other parts information such as diagrams of the assemblies and/or all the individual parts included on the assemblies involved in the service procedure. For example, a viewer watching the “roller replacement” movie clicks the “Assembly Parts” 157b (FIG. 2) to see all the assemblies and/or all parts from the assemblies involved in the service procedure such as the paper feed unit, rollers, shafts, clutches, bushings, springs, etc. Optionally too, it also provides a shopping cart or means to obtain a shopping cart to order at least one of the parts and/or assemblies. The “Model Parts” 157c (FIG. 2) provides information of all the parts comprising the apparatus. For example, when the viewer clicks the “Model Parts” 157c (FIG. 2), service information of parts, such as diagrams including all the parts and assemblies of the apparatus are provided, thus allowing the viewer see parts information of assemblies or other sections of the machine not included by the movie demonstrating the service procedure. The “All Parts” 157d (FIG. 2) provides access to the parts information of several apparatuses. For example, the viewer clicks the “All Parts” option 157d (FIG. 2) and a selective protocol appears including a menu allowing the client to choose a type of machine and manufacturer of choice, such as Canon printer, HP printers, and Xerox printers. The “Search Parts” 157e (FIG. 2) provides a search engine for searching a particular part, assembly, and/or machine. For example a viewer activates the “Search Parts” 157e (FIG. 2) and enters in the query of the search engine the text “pickup rollers.” As a result, the search engine provides pickup roller results. Noteworthy, in FIG. 1 the button labeled “Search” 158 (FIG. 1), has a different purpose, or utilizes a different data source for the search engine to retrieve. Please also note, that the parts search option 157e (FIG. 2) could have been an option under the “Search” button 158 (FIG. 1) instead. In this manner, this two examples illustrate that the location and/or types of service information can be allocated and/or identified under a variety of combinations, possibilities and even means.

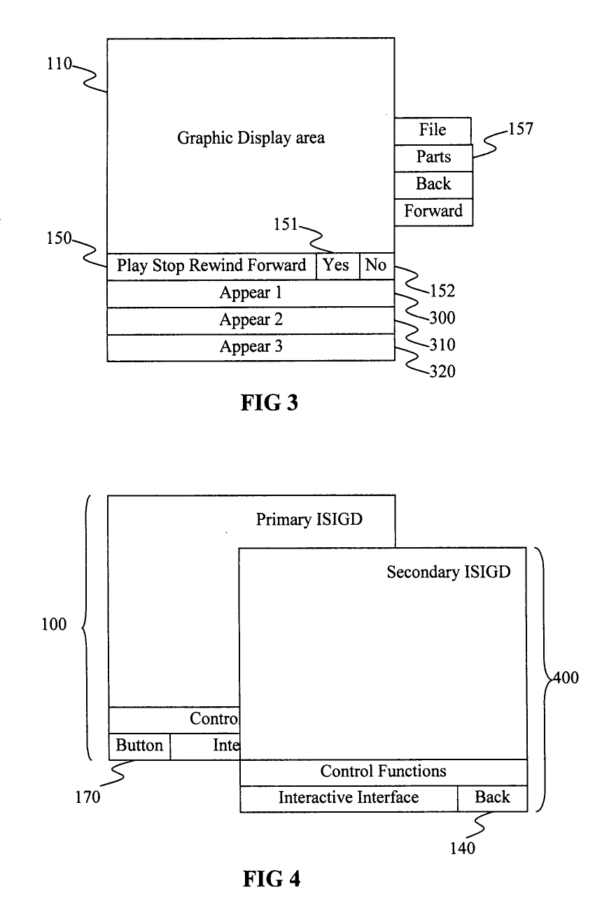

FIG. 3 illustrates another non-limiting example of an ISIGD, this time comprising and illustrating several types of button behaviors such as: Static buttons, the Semi-static buttons, and the Dynamic buttons. The Static button, like its name, has a static behavior, that is, provides access to its associative service information at all times. For example, one function preferably available at all times in a service procedure is that possibly assigned to the “Parts” button 157 (FIG. 3), allowing the viewer to have access to parts information at any time desired. The Semi-static button provides access to its associative information only sometimes. For example one semi-static button is that which its behavior is preferably assigned to the “Yes” button 151 (FIG. 3), and to the “No” button 152 (FIG. 3). The viewer can see the “Yes” button 151 (FIG. 3), and “No” button 152 (FIG. 3) at all times, yet they become functional or available only during those times wherein a positive answer or a negative answer is required from the viewer. Clicking a semi-static button during its non-operational times, results in no action(s) and/or an optional warning can de issue indicating that no file or information is available at the time. The Dynamic button is capable of appearing and/or disappearing upon accessibility. For example, the viewer is watching a demonstration of rollers is being removed, and the “Appear 1” button 300 (FIG. 3) labeled “Can not remove” appears indicating the viewer that if such an unfortunate service event occurs, the viewer can accordingly activate or click the button to suggestively see another service information such as another movie demonstrating a different service procedure used to remove stuck roller(s). The “Appear 2” button 310 (FIG. 3), and “Appear 3” button 320 (FIG. 3) are illustrated to suggest that is possible to have several dynamic type buttons and other type buttons co-existing simultaneously at any particular time; each of which is addressing a particular service information such as a function, necessity, association, protocol, part and/or action associated and/or demanded by the service information or procedure and/or the viewer alike.

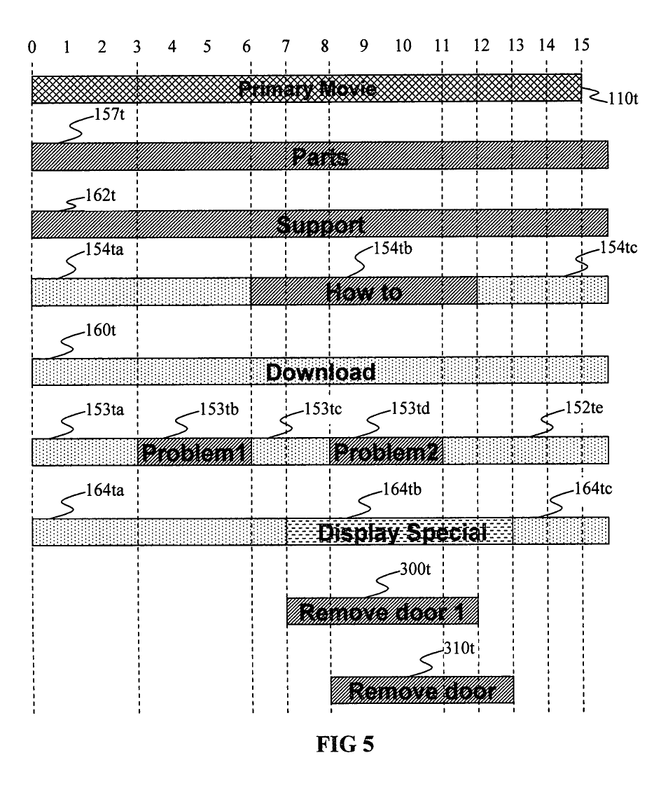

FIG. 4 illustrates two service information interfaces interacting, such as the primary ISIGD 100 (FIG. 4), and the secondary ISIGD 400 (FIG. 4). In this example, when the viewer double clicks the custom button 170 (FIG. 4) on the first ISIGD 100 (FIG. 4), the second ISIGD 400 (FIG. 4) is provided, demonstrating service information referent to the custom procedure or button. Clicking the “Back” button 140 (FIG. 4) on the second ISIGD 400 (FIG. 4) ends the auxiliary service information or procedure and returns view or controls to the primary ISIGD 100 (FIG. 4).

FIG. 5 illustrates a non-limiting graph of exemplary timelines of several exemplary service information(s). The timeline of a primary movie 110t (FIG. 5) demonstrating a service procedure is illustrated lasting a total of 15 seconds. The timelines of additional service information comprising other information associated to the service procedure are illustrated below the movie's timeline. As shown, the “Parts” timeline 157t (FIG. 5) indicates that accessibility to parts information of the service procedure in the movie is available for more than 15 seconds or the entire time lapse of the primary movie. It also indicates that such information is available at all times during the primary movie 110t (FIG. 5). The “Support” timeline 162t (FIG. 5) indicates that support information and/or protocols are available at all times during the movie (exceeding 15 seconds). On the other hand, the “How to” function and/or button is available only for a few seconds of the movie. When the movie begins, the first portion of the “How to” timeline 154ta (FIG. 5) indicates that no service information is available. Then, on the sixth second, the second portion of the “How to” timeline 154tb (FIG. 5) indicates that its information is available but only for six seconds. On the twelfth second, the third portion of the “How to” timeline 154tc (FIG. 5) indicates that its information is no longer available. The “Download” timeline 160t (FIG. 5) illustrates that service information associated to any download data is not available throughout the entire duration of the primary movie 110t (FIG. 5). The first portion of the “Problem” timeline 153ta (FIG. 5) indicates that information is not available. In the second portion, the “Problem” timeline 153tb (FIG. 5) the graph indicates that problem information such as another movie per se, is available for a period of 3 seconds. In the third portion (beginning on the 6^{th} second), the “Problem” timeline 153tc (FIG. 5) indicates that information is not available for a period of 2 more seconds. Then, on the fourth portion (beginning on the 8^{th} second), the “Problem” timeline 153td (FIG. 5) indicates that service information such as a different movie demonstrating a completely different problem procedure is available for 3 seconds. The final or fifth portion (beginning on the 11^{th} second) indicates that no more service information is available during the remaining movie 110t (FIG. 5). The first portion of the “Display special” timeline 164ta (FIG. 5) indicates that no such information is available for 7 seconds. However, in the second portion (beginning of the 7^{th} second) of not displaying specials information, the “Display Specials” timeline 164tb (FIG. 5) indicates that information displaying specials on sales or other is now available or being displayed for a period of 6 seconds. In the third portion (beginning of the 13^{th} second) of specials, the “Display Special” timeline 164tc (FIG. 5) indicates that no other information associated displaying specials and/or information of specials is available for the remaining portion of the movie 110t (FIG. 5). The “Remove door 1” timeline 300t (FIG. 5) appears on the 7^{th} second of the movie indicating a dynamic button providing access to service information, such as a movie demonstrating a service procedure involving a first door is now available. This Dynamic button or image is available for a period of 5 seconds, disappearing on the 12^{th} second of the movie 110t (FIG. 5). The “Remove door 2” timeline 310t (FIG. 5) indicates a second dynamic input image element, that becomes visible on the 8^{th} second and lasts for 4 seconds. The secondary button provides service information comprising a second door different to the first door. In fact this example illustrates two Dynamic buttons sharing time and existence, at least for a portion in time.

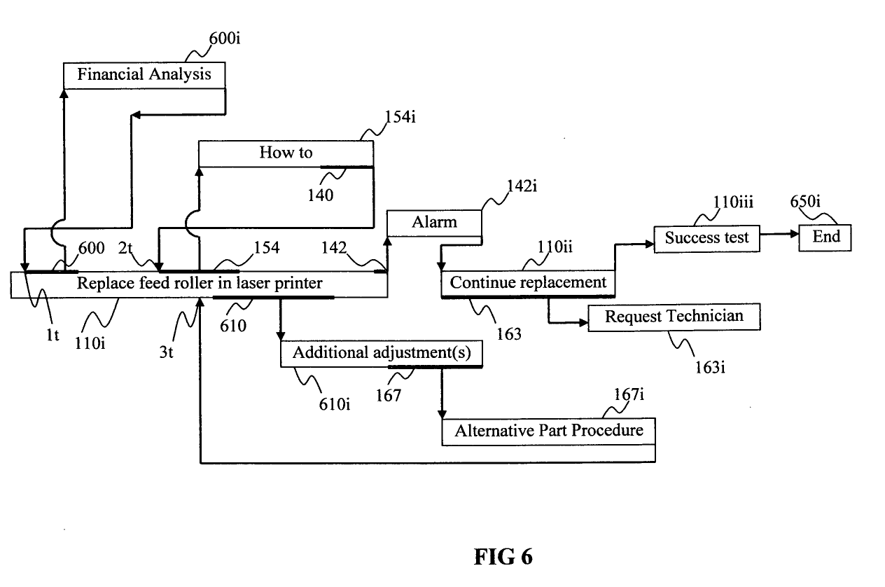

FIG. 6 illustrates a non-limiting timeline flow chart of some sample buttons of an exemplary ISIGD. The timeline of the primary service information 110i (FIG. 6) illustrates the timelines of four buttons such as the “Financial Analysis” button 600 (FIG. 6), the “How to” button 154 (FIG. 6), the “Additional Adjustments” button 610 (FIG. 6), and the “Alarm” button 142 (FIG. 6). When the “Financial Analysis” button 800 (FIG. 6) is pushed or activated, the “Financial Analysis” information 600i (FIG. 6) is provided, such as a movie discussing the operating cost of the present apparatus and/or a new apparatus. After 600i (FIG. 6) is delivered, the viewer is returned automatically to a point it (FIG. 6) in the timeline of the primary service information 110i (FIG. 6). Activation of the “How to” button 154 (FIG. 6) produces the “How to” information 154i (FIG. 6), such as another movie demonstrating how to remove the roller of a printer. Before the “How to” information 154i (FIG. 6) is finished, the diagram illustrates a “Back” button 140 (FIG. 6), that when pushed, returns the viewer back to another point in time 2t (FIG. 6) of the primary service information 110i (FIG. 6). Activating of the “Additional adjustments” button 610 (FIG. 6) provides the viewer the “Additional adjustment” information 610i (FIG. 6), such as a slideshow demonstrating adjustment of a solenoid in the immediate area of the service procedure being demonstrated by the primary service information 110i (FIG. 6). After delivering approximately 50% of the content of the “Additional adjustments” information 610i (FIG. 8), the “Alternative procedure” button 167 (FIG. 6) of the ISIGD allows for the “Alternative Part Procedure” information 167i (FIG. 6) that after being delivered, returns the viewer to the point in time 3t (FIG. 6) of the primary service information 110i (FIG. 6). Towards the end of the “replace feed roller in laser printer” procedure or primary service information 110i (FIG. 6), the “Alarm” button 142 (FIG. 6) begins flashing (or other) warning the viewer, but also stopping the demonstration of the procedure. At this point, the viewer must click the “Alarm” button 142 (FIG. 6) in order to proceed or continue with the demonstration of the procedure which in this example is contained on the other service information named “continue replacement” 110ii (FIG. 6). Clicking of the “Alarm” button 142 (FIG. 6) delivers the “alarm” information 142i (FIG. 6) that after being delivered, automatically continues with the “continue replacement” information 110ii (FIG. 6). FIG. 6 also illustrates that during the “continue replacement” information 110ii (FIG. 6) the “Request Technician” button 163 (FIG. 6) is available. Clicking the “Request Technician” button 134 (FIG. 6) begins the “Request Technician” information 163i (FIG. 6) such as a contacting protocol to connect the viewer with a technical dispatch center or an email protocol to send a request. After completing the observation of the “Continue replacement” information 110ii (FIG. 6), the “Success test” information 110iii (FIG. 6) is automatically provided, such as a demonstrating a protocol to inspect the apparatus and its operation. Finally, the “end” information 650i (FIG. 6) is provided, such as a protocol requesting viewer comments and information about their service experience.

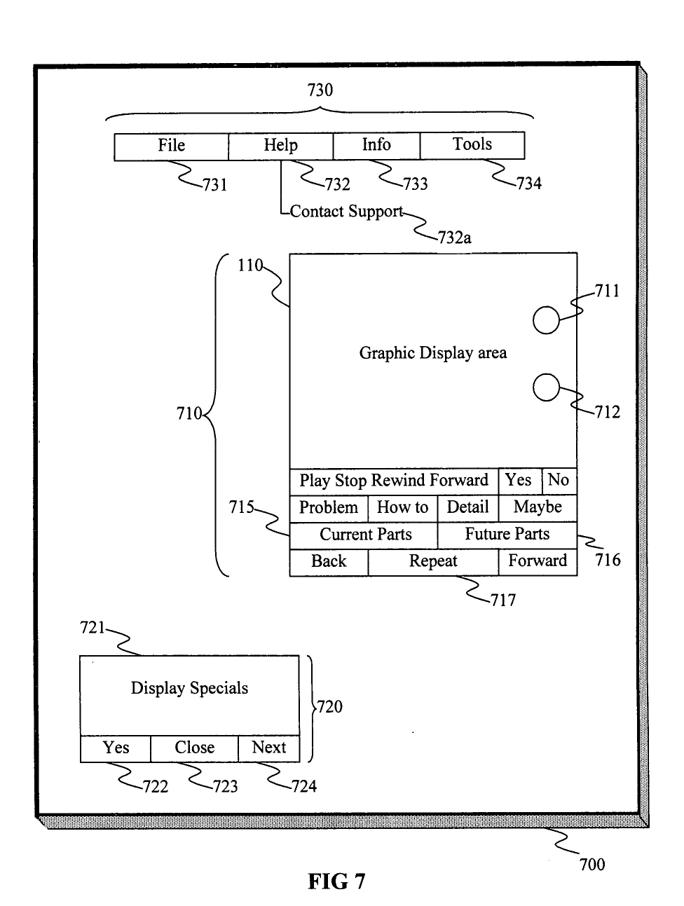

FIG. 7 illustrates a non-limiting example of a display of a smart system 700 (FIG. 7), such as the display of a computer, portable computer, PDA, cell phone, etc. displaying an exemplary ISIGD 710 (FIG. 7), an exemplary toolbar 730 (FIG. 7), and an exemplary display for Specials 720 (FIG. 7) for providing advertising information. The toolbar 710 (FIG. 7), provides four menus such as the “File” menu 731 (FIG. 7), the “Help” menu 732 (FIG. 7), the “Info” menu 733 (FIG. 7), and a “Tools” menu 734 (FIG. 7). The respective menus provide sub-menus and/or other information, such as the media for “contact technical support” 732a (FIG. 7); which in this example is accessible on the “Help” menu 732 (FIG. 7) of the toolbar 730 (FIG. 7). The ISIGD 710 (FIG. 7) handles information regarding the preventive maintenance of an apparatus. The interactive element “A” 711 (FIG. 7) and “B” 712 (FIG. 7) are part of an interactive movie being displayed on the graphic display area 110 (FIG. 7). For example, the movie displays the “A” and “B” images on the screen, which the viewer must click to respond to the movie content. The “Current Parts” 715 (FIG. 7) provides information of parts involved in the preventive maintenance procedure(s). The “Future Parts” provides information of parts and/or kits needed on future preventive maintenance of the apparatus. For example, a viewer clicking in the “Future Parts” is presented with ordering protocols to order or schedule the order the parts to be used or replaced on upcoming preventive maintenance procedures. The “Repeat” 717 (FIG. 7) button, when clicked by the viewer, repeats the movie or portion of the movie. The display for specials 720 (FIG. 7) includes a “Display Specials” area 721 (FIG. 7) for displaying media such as a small clip of a commercial, a “Yes” button 722 (FIG. 7) for responding or agreeing to the commercial, a “Close” button 723 (FIG. 7) for terminating the “Display for Specials” 720 (FIG. 7) window, and a “Next” button 724 (FIG. 7) for viewing other commercials and/or specials associated to the ISIGD 710 (FIG. 7).

Noteworthy, without departing from the original spirit of the inventive method disclosed herein, many types of service information and means can be removed and/or added. For example, the computer's microphone can be used to allow speech entry from the viewer, such as saying the word “Yes” into the microphone for responding “affirmatively” to content on the ISIGD. In addition, other issues such as source of service information, forms of service information, controls of service information, associations of the service information, source for the associations of the service information, identifications, and others can all be differently manipulated and/or architected. For example, to achieve control of the delivery of service information, the buttons are controlled. In another controlling sample, the button's associations are controlled. In a further controlling example, the service information (content) is controlled. In another further example, the information for producing the association is encrypted within the service information. In a yet further example, the information for producing the association is provided in a different file, etc.

The enablements described in detail above are considered novel over the prior art of record and are considered critical to the operation of at least one aspect of the method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

### CONCLUSION

From the present disclosed inventive method, it can be appreciated a novel method for providing an interactive graphic information display for providing service information of an apparatus, such as procedures, protocols, parts and other service information of the apparatus. In addition the inventive method discloses optional means for communication, support, and commerce abilities.

1. A method for providing an interactive graphic display for demonstrating a service information of an apparatus, the method comprising the steps of:
a) Providing a display for providing a movie
b) Implementing said movie for demonstrating a service procedure of an apparatus
c) Providing an input responsive image , such as a button
d) Associating to said button at least one service information associated to said service procedure
e) Providing said service information.
